(19) United States
(12) Patent Application Publication
(10) Pub. No.: US 2018/0131692 A1
(43) Pub. Date: May 10, 2018

(54) SYSTEM AND A METHOD FOR APPLYING DYNAMICALLY CONFIGURABLE MEANS OF USER AUTHENTICATION

(71) Applicant: Idefend LTD., Tel Aviv (IL)

(72) Inventors: Ori KATZ-OZ, Kfar Oranim (IL); Noam ROTEM, Lapid (IL)

(21) Appl. No.: 15/678,361

(22) Filed: Aug. 16, 2017

Related U.S. Application Data
(60) Provisional application No. 62/419,632, filed on Nov. 9, 2016.

(51) Int. Cl. H04L 29/06; G10L 17/22

(52) U.S. Cl. CPC H04L 63/0861; G10L 15/1822; G10L 17/22; H04L 63/10

(57) ABSTRACT

The present invention provides a method for dynamically adjusting authentication procedure of user access to an authorizing entity or action using a computerized device, said method implemented by one or more processors operatively coupled to a non-transitory computer readable storage device, on which are stored modules of instruction code that when executed cause the one or more processors to perform:
k. online tracking user behavior including login action in response to authentication procedure requirement, continuous passive behavior after login or active behavior in response to authentication procedure requirement;
l. analyzing user behavior and authentication data received from the user;
m. determining sensitivity authentication parameter based on analyzed and track behavior data;
n. dynamically changing authentication procedure requirement based on determined sensitivity authentication parameter user profile and/or authorizing entity;
o. dynamically changing authentication assessment based on determined sensitivity authentication parameter.

### BACKGROUND

Unauthorized access into handheld cellphone devices or laptops is an increasing problem for the industry. Hackers and the cyber industry are engaged in a constant technological race in which they try to defeat each other's latest improvements and advancements. As such, the industry always has a need for more sophisticated authentication and protection methods.

In recent years, increasingly more sophisticated methods for protecting devices have been developed. These have come to include hand and finger recognition, and voice and video detection.

### SUMMARY OF THE PRESENT INVENTION

The present invention provides a method for dynamically adjusting authentication procedure of user access to an authorizing entity or action using a computerized device, said method implemented by one or more processors operatively coupled to a non-transitory computer readable storage device, on which are stored modules of instruction code that when executed cause the one or more processors to perform:
a. online tracking user behavior including login action in response to authentication procedure requirement, continuous passive behavior after login or active behavior in response to authentication procedure requirement;
b. analyzing user behavior and authentication data received from the user;
c. determining sensitivity authentication parameter based on analyzed and track behavior data;
d. dynamically changing authentication procedure requirement based on determined sensitivity authentication parameter user profile and/or authorizing entity;
e. dynamically changing authentication assessment based on determined sensitivity authentication parameter.

According to some embodiments of the present invention the initiating authentication procedure include sending instructions to the user terminal, according to the control data and the triggering events.

According to some embodiments of the present invention the method further comprising the step of authenticating the user's identity by requiring the user to perform specific actions while recording them on video, and verifying the performance of the said actions by analyzing the said video recordings.

According to some embodiments of the present invention the step of identifying a triggering event, originating either by a system condition or user action for activating active monitoring

According to some embodiments of the present invention the method further comprising the step of determining authentication assessment score based on predefined authentication rules, user profile, entity profile by integrating all authentication analyses comparison results using dynamically updated authentication weights

The method of claim 1 further comprising the step of receiving behavioral data including at least one of: motion data of user organs or movement of user smartphone device, typing actions of the user or Mouse cursor movement.

According to some embodiments of the present invention the method further comprising the step of analyzing all Motion data according to predefined rules such user identified normal behavior.

According to some embodiments of the present invention based on sensitivity parameters determining control parameters for passive capturing module using predefined sensitivity rules (e.g. frequency of capturing user face)

According to some embodiments of the present invention the method further comprising the step of wherein based on sensitivity parameters determine control parameters for active capturing module using predefined sensitivity rules

According to some embodiments of the present invention the method further comprising the step of updating authentication weights for each type of authentication methods for assessment module based on sensitivity parameters, user profile and entity profile or determine level of comparison thresholds parameters

According to some embodiments of the present invention the method The method of claim 1 wherein the sensitivity parameters determination are further based on context parameters including at least one of: geo location, time, IP address.

The present invention provides a system for dynamically adjusting authentication procedure of user access to an authorizing entity or action using a computerized device, said system comprising one or more processing devices operatively coupled to a non-transitory storage device, on which are stored modules of instruction code that when executed cause the one or more processing devices to perform:
a. monitoring module for online tracking user behavior including login action in response to authentication procedure requirement, continuous passive behavior after login or active behavior is response to authentication procedure requirement;
b. Analysis module for analyzing user behavior and authentication data received from the user;
c. Authentication control module for determining sensitivity authentication parameter based on analyzed and track behavior data and dynamically changing authentication procedure requirement based on determined sensitivity authentication parameter user profile and/or authorizing entity;
d. Authentication assessment module dynamically changing authentication assessment based on determined sensitivity authentication parameter

According to some embodiments of the present invention the initiating authentication procedure include sending instructions to the user terminal, according to the control data and the triggering events.

According to some embodiments of the present invention the authentication control module further comprising the step of authenticating the user's identity by requiring the user to perform specific actions while recording them on video, and verifying the performance of the said actions by analyzing the said video recordings.

According to some embodiments of the present invention the monitoring comprising the step of identifying a triggering event, originating either by a system condition or user action for activating active monitoring

According to some embodiments of the present invention thee authentication control module further comprising the step of determining authentication assessment score based on predefined authentication rules, user profile, entity profile by integrating all authentication analyses comparison results using dynamically updated authentication weights

According to some embodiments of the present invention the monitoring, module further comprising the step of receiving behavioral data including at least one of: motion data of user organs or movement of user smartphone device, typing actions of the user or Mouse cursor movement.

According to some embodiments of the present invention the monitoring, module further comprising the step of analyzing all Motion data according to predefined rules such user identified normal behavior.

According to some embodiments of the present invention the wherein based on sensitivity parameters determining control parameters for passive capturing module using predefined sensitivity rules (e.g. frequency of capturing user face)

According to some embodiments of the present invention the wherein the authentication control module further comprising the step of wherein based on sensitivity parameters determine control parameters for active capturing module using predefined sensitivity rules

According to some embodiments of the present invention the wherein authentication control module further comprising the step of updating authentication weights for each type of authentication methods for assessment module based on sensitivity parameters, user profile and entity profile or determine level of comparison thresholds parameters

According to some embodiments of the present invention the sensitivity parameters determination are further based on context parameters including at least one of: geo location, time, IP address.

### BRIEF SUMMARY

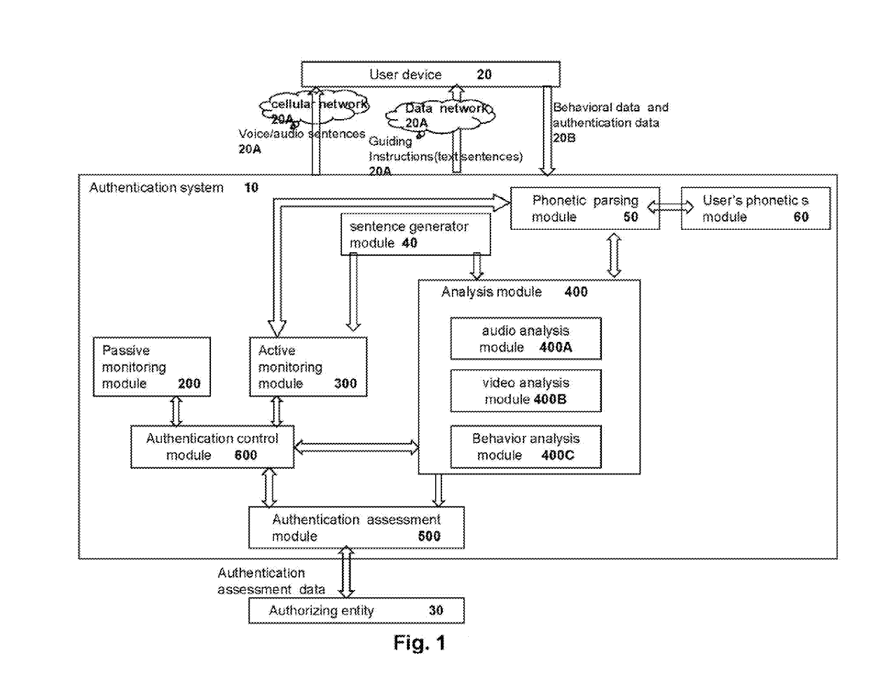

FIG. 1 is a block diagram of the authentication system modules environment according to some embodiments of the present invention.

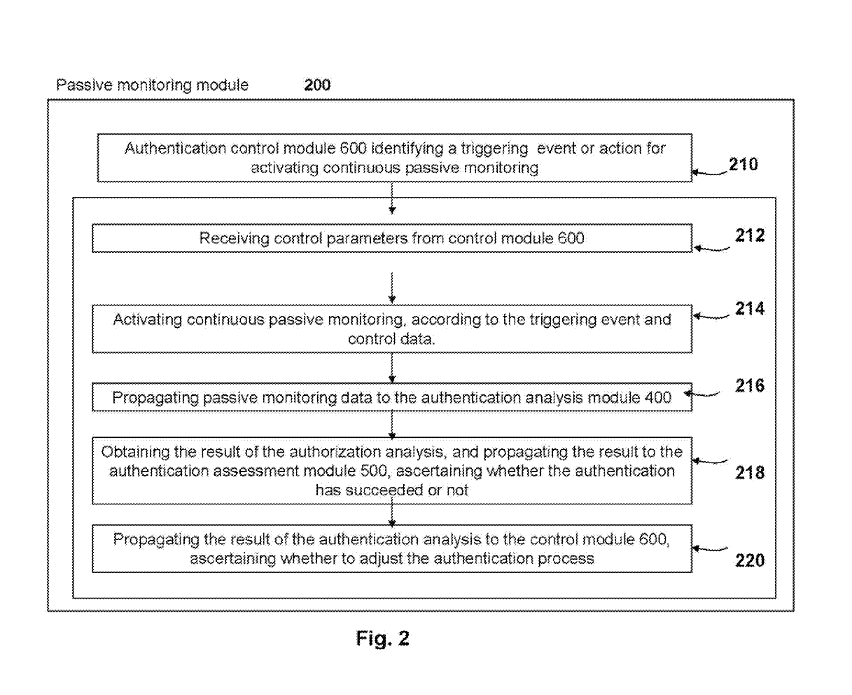

FIG. 2 is an illustration flow chart of the Continuous Passive Capturing Behavior Module processing, according to some embodiments of the present invention.

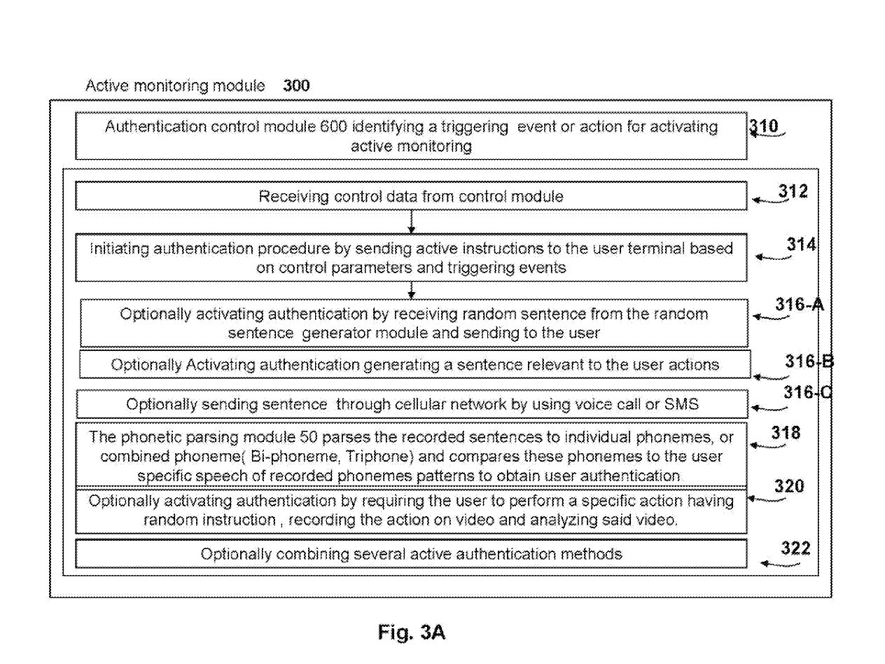

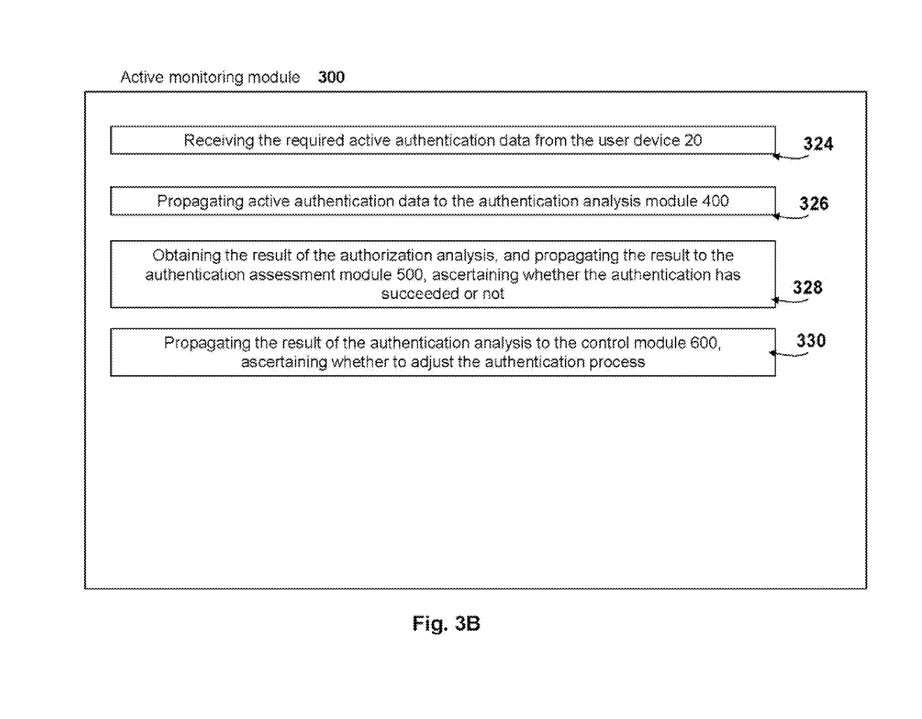

FIGS. 3A and 3B are an illustration flow chart of the Active capturing behavior module, according to some embodiments of the present invention.

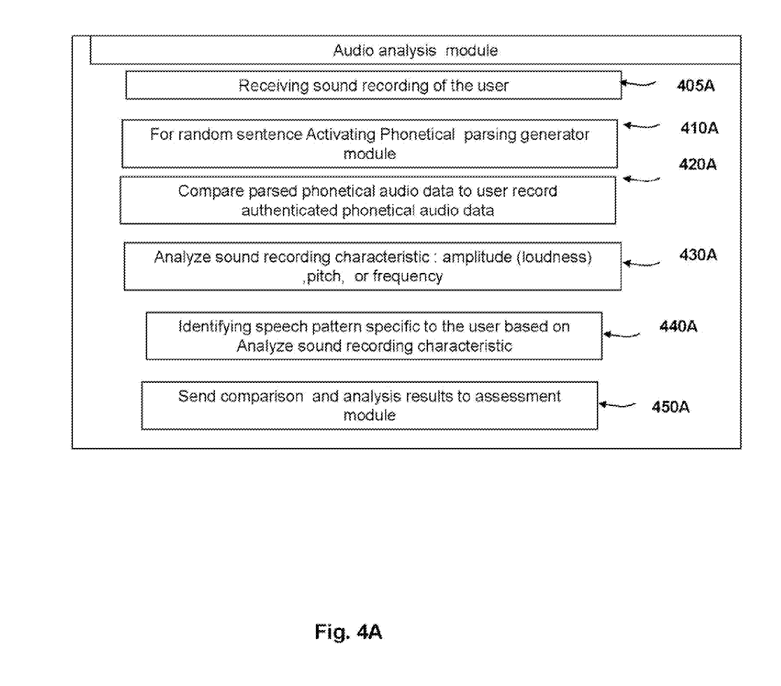

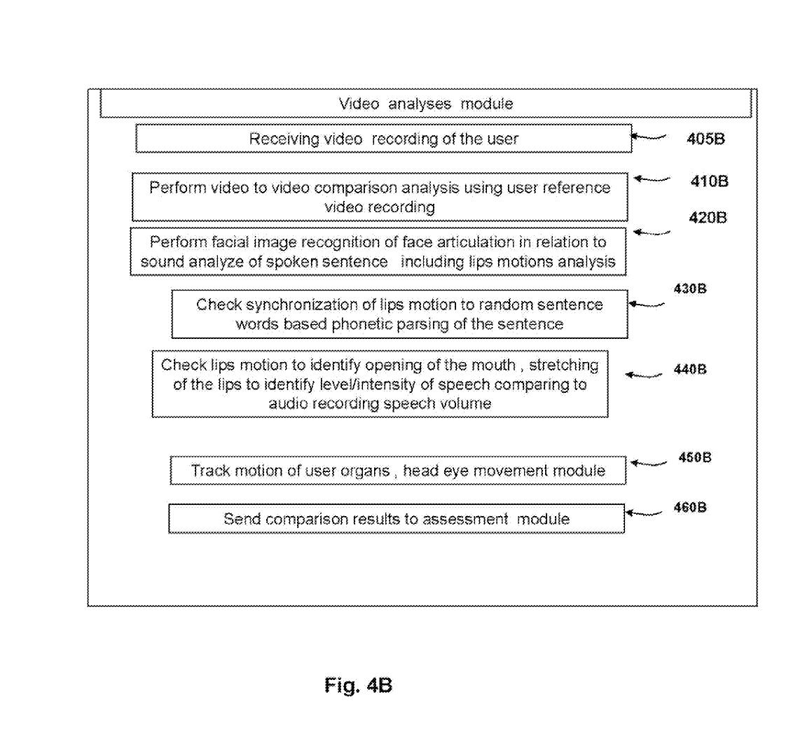

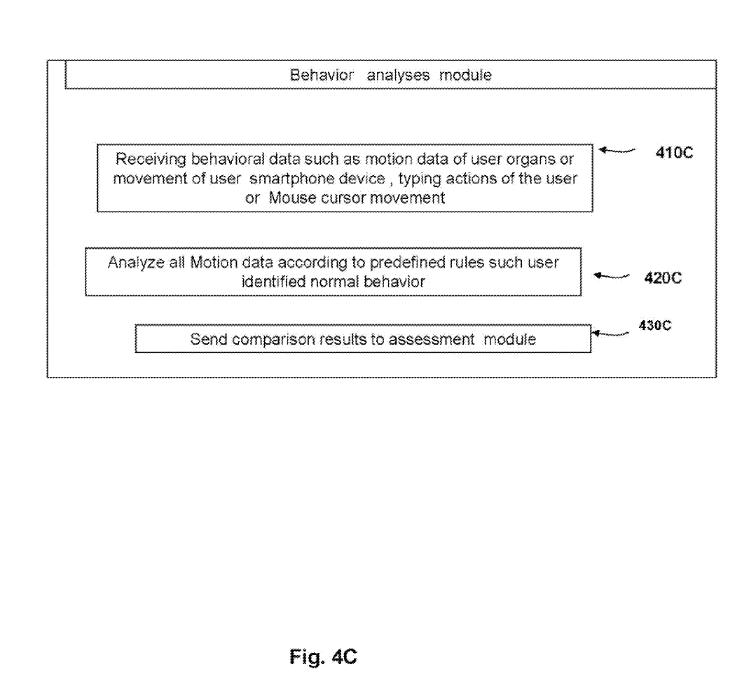

FIG. 4A is an illustration flow chart of the audio analysis module, which analyses the phonetic structure of an audio snippet that was recorded by the user, according to some embodiments of the present invention.

FIG. 4B is an illustration of a flow chart of the video analysis module, which analyses a video snippet provided by the user and determines a phonetic structure by lip-reading, according to some embodiments of the present invention.

FIG. 4C is an illustration of a flow chart of the behavior analysis module, according to some embodiments of the present invention.

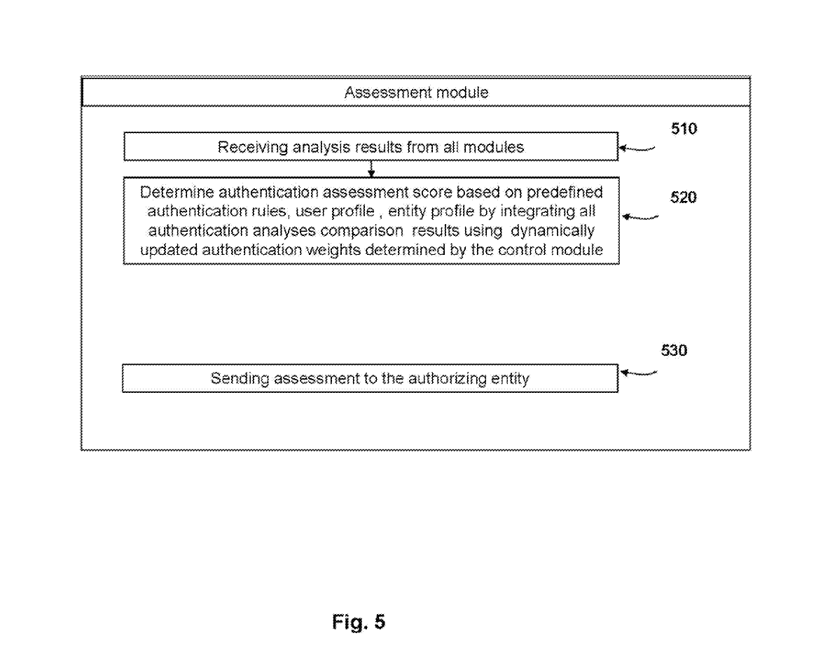

FIG. 5 is an illustration of a flow chart of the authentication assessment module, according to some embodiments of the present invention.

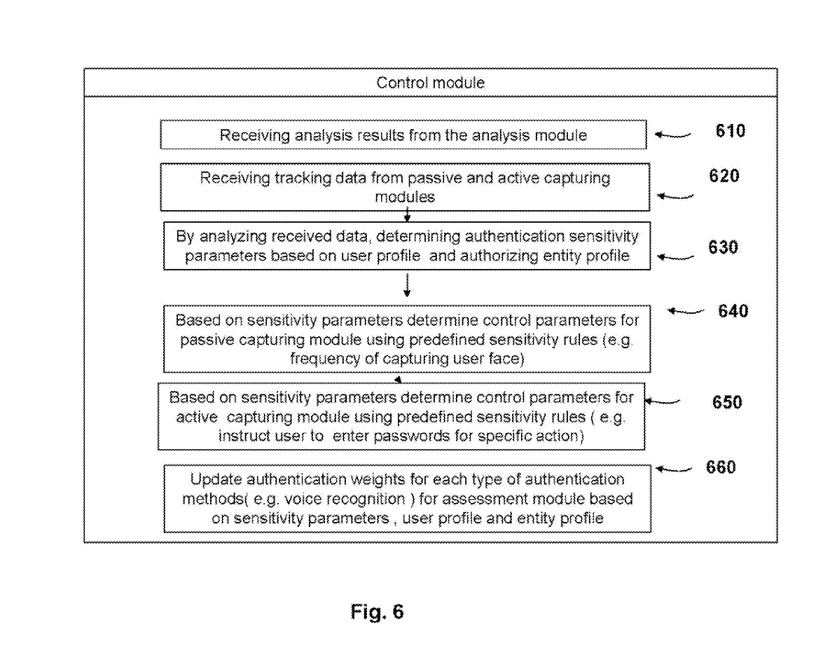

FIG. 6 is an illustration of a flow chart of the authentication control module, according to some embodiments of the present invention.

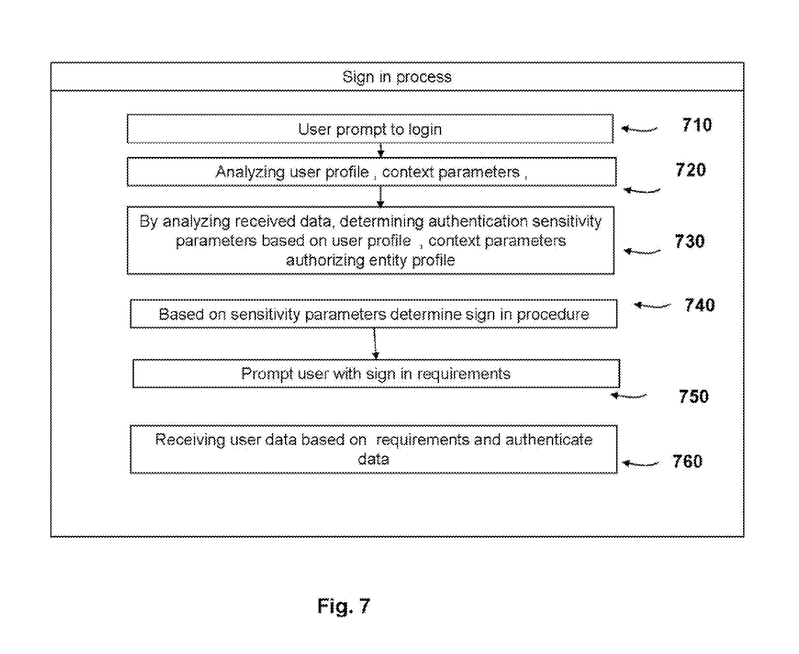

FIG. 7 is an illustration of a flow chart of the Sign in process module, according to some embodiments of the present invention.

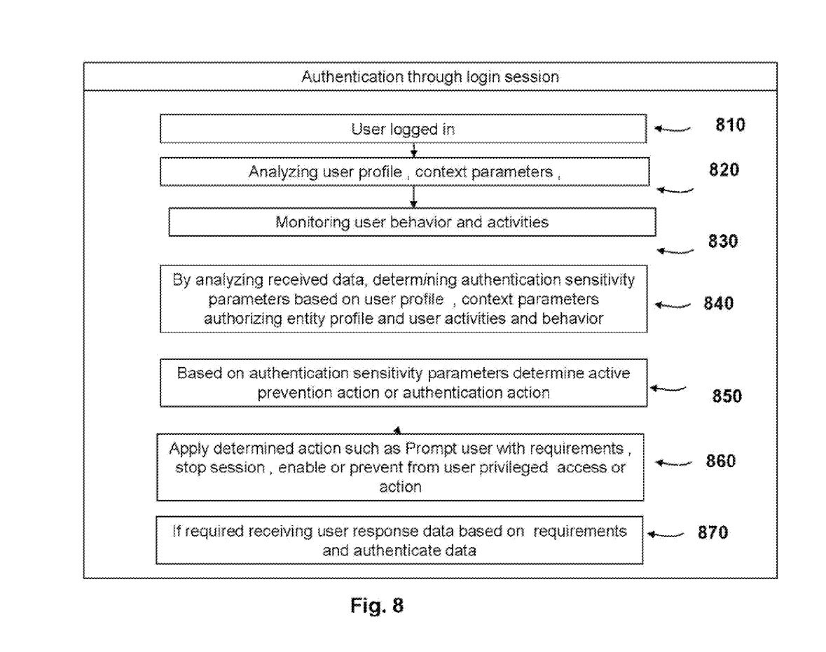

FIG. 8 is an illustration of a flow chart of the Authentication through login session module, according to some embodiments of the present invention.

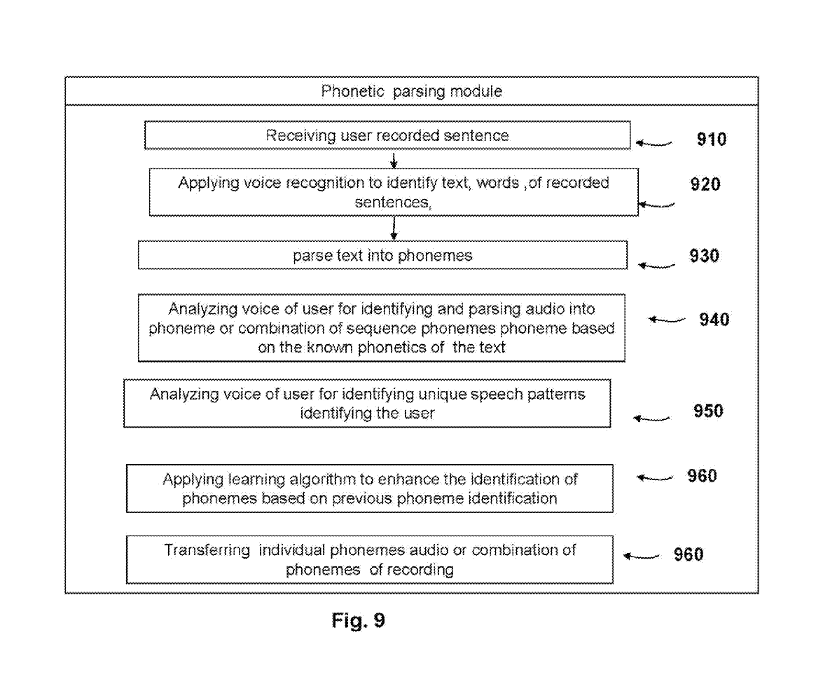

FIG. 9 is an illustration of a flow chart of Phonetic parsing module, according to some embodiments of the present invention.

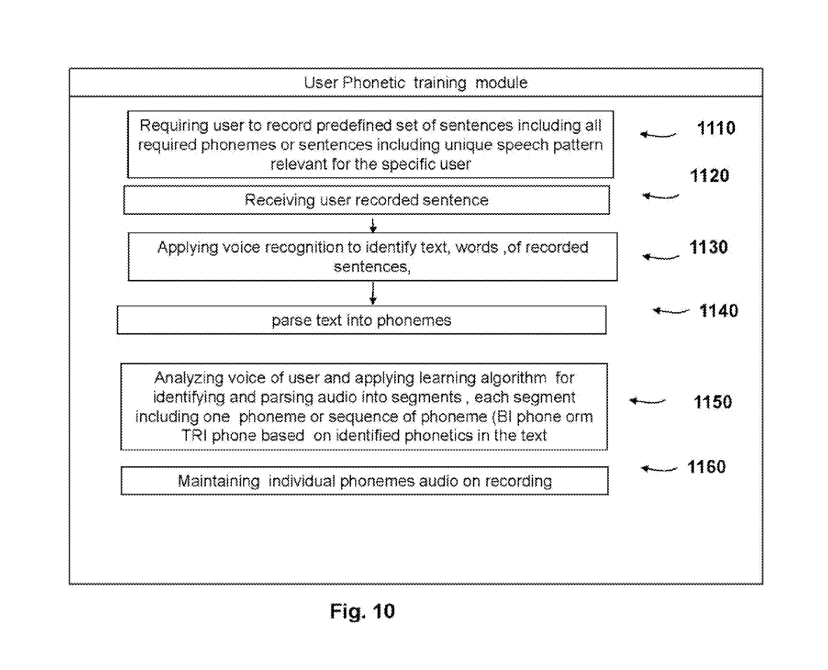

FIG. 10 is an illustration of a flow chart of User Phonetic training module, according to some embodiments of the present invention.

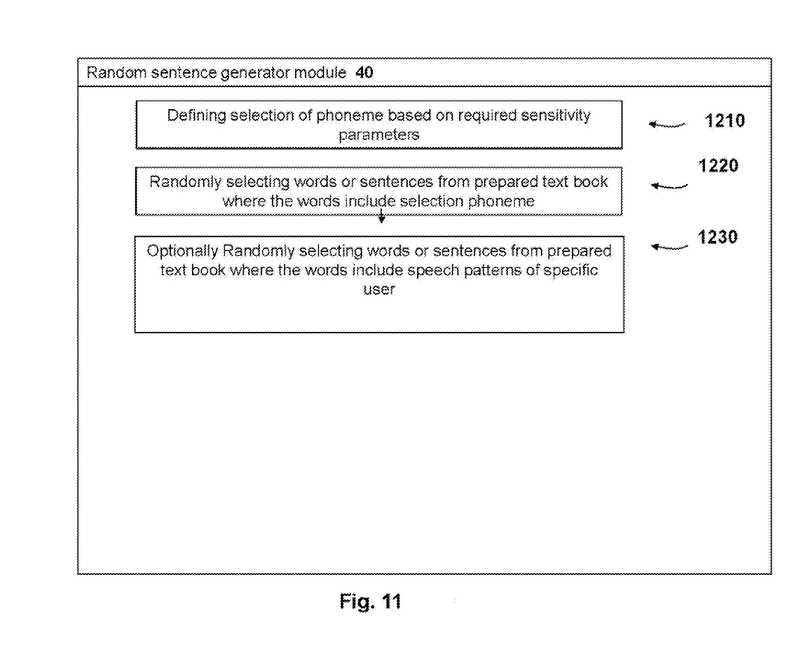

FIG. 11 is an illustration of a flow chart of Random sentence generator module, according to some embodiments of the present invention.

### MODES FOR CARRYING OUT THE INVENTION

Following is a table of definitions of the terms used throughout this application.

| Term | Definition |
|---|---|
| Authorizing | Any organizational entity which applies user authentication via the |
| entity | system disclosed in the present invention (e.g. a bank which wishes |
| | to verify the identity of a customer) |
| User | A user which attempts to obtain access to resources provided by the |
| | authorizing entity via any kind of computerized system (e.g. mobile |
| | phone, personal computer, terminal workstation, etc.) |
| User profile | A set of parameters describing the user, and determining the assets |
| | and capabilities provided to that user by the authorizing entity (e.g. |
| | User name, role and authorization level within an organization, |
| | credit history in a bank) |
| Triggering | An event which, according to the policy dictated by the authorizing |
| event | entity, requires the activation of a user authentication procedure. |
| | The event may be derived from an action taken by the user himself |
| | (e.g. a client of a bank, requesting to transfer money between |
| | accounts) or by an event which is not directly linked to the user |
| | (e.g. a predefined condition, set in a factory or assembly line, which |
| | requires an authorized user's attention) |
| Active | A method of user authentication which requires some action on the |
| authentication | part of the user (e.g. type a username and password, or say one's |
| procedure | name in front of a camera, per form action of moving head or hand |
| | according to random instruction) |
| Passive | A method of user authentication which does NOT require action on |
| authentication | the part of the user (e.g. a camera which continuously takes images |
| procedure | of the person standing in front of it, and verifies their identity by |
| | means of image processing) |
| Sensitivity | Parameters which are dictated by the Authorizing entity, to |
| parameters | determine: |
| | 1. The required method of authentication |
| | 2. Specific properties of the selected method |
| | 3. The level of certainty provided said authentication |
| | For example: the method of authentication could be passive user |
| | face recognition through image processing, and the rate of acquired |
| | user facial images may be low, providing a moderate level of |
| | certainty that the user's identity remained the same throughout the |
| | monitored period. |

FIG. 1 is a block diagram depicting the authentication system (10) environment, according to some embodiments of the present invention. The authentication system 10 enables a user device 20 to access an application service of an authorizing entity 30.

The authentication system 10 sends the user device 20 authentication requirements and guiding instructions 20A, and receives behavioral data and authentication data from the user's device 10 (20B) in return.

The authentication system 10 dynamically enables changing the authentication procedure and the authentication procedure's properties according to various parameters, such as:
User profile (e.g. user's credit history., age, gender, title, organization etc.)
Policies and requirements presented by the authorized entity (e.g. a bank's web page)
Predefined sensitivity parameters
Time of the day
The type of the user device
User's authentication history

The passive monitoring module 200 continuously gathers user authentication data and behavioral data which do not require feedback from the user (e.g. continuously capturing video frames of the user). The gathering of the said data may initiate following a triggering event set by the authorizing entity, or according to a predefined schedule.

Examples for authentication data include: facial data, voice data, passwords.

Examples for behavioral data include: monitored phone movements, mouse movements or mouse clicks.

The passive monitoring module 200 propagates the said authentication data and behavioral data to the Analysis Module 400 and the Analysis Control Module 600

The active monitoring module 300 gathers active user authentication data. This data is acquired during any authentication process that requires the user 20 to take action (e.g. introducing a user name and password, or performing a required task according to instructions). All acquired active user authentication data is recorded and propagated to the analysis module 400 and the control module 600.

An audio analysis module 400A receives data that contains the recorded sound of the user, and sends it to the Phonetic Parsing Module 50, where the phonetic data is interpreted and processed.

The Users Phonetics Module 60 is responsible for obtaining user-specific phonetic patterns. It is activated during the set-up process, as part of the machine learning training, or as new users are introduced into the system.

The Users Phonetics Module 60 requires newly introduced users to record a set of sentences which may include all possible phonemes. The said recordings are then parsed by the Phonetic parsing Module 50, to identify patterns of utterance for each phoneme. The recordings and patterns of the user's utterance of individual phonemes are stored in a user's phonetic database (not shown in FIG. 1) within the Users Phonetics Module 60.

In some embodiments of the present invention, the phonetic data obtained from the user is compared to expected phonetic data obtained by the Users Phonetics Module 60, to determine user authentication. Following is a non-limiting example to such a process of authentication through speech:
Phonetic patterns specific to single users are produced in the Users Phonetics Module 60 during a preliminary process of machine learning training or user enrollment.
During the process of authentication, the user will be required to utter a randomly selected sentence.
The phonemes uttered by the user will serve to ascertain that he/she actually responds correctly to the requirement, and that the obtained audio is, in fact, produced by the specified user.

According to some embodiments, the user is required to utter a sentence actual relevance to the context of activities he is currently taking at website or application. Having the actual information conveyed in the user's utterance of speech may be used to enhance the authentication process. For example, during a financial transaction, the user may be required to narrate their action as in: “I am transferring 100 dollars to the account of William Shakespeare”.

According to some embodiments, the information conveyed in the authentication sentence will be imperative to processes that are taking place in the authentication system's 10 environment. For example, a pilot may be required to say “I am now lowering the landing gear” as part of security protocol.

The Phonetic Parsing Module 50 returns the results of the said analysis back to the audio analysis module 400A. The results are propagated to the Authentication Assessment module 500 for further assessment and validation.

The random sentence generator module 40 creates a random string of words, consisting a meaningful or meaningless sentence. According to some embodiments, this sentence may be presented to the user, upon which they would need to read it as part of the authentication process.

According to some embodiments, the random sentence generator module 40 may randomly select sentences from a database of sentences (not shown in FIG. 1). This database may contain texts such as books and newspapers for this purpose.

The video analysis module 400B receives data that contains the recorded video of a user and uses that data to run various tests to authenticate the user. Non-limiting examples for such tests include:
Video to video analyzing,
Analysis of lips motion, for the purpose of authentication of uttered sentences. This procedure may be correlated to the phonetic analysis implemented by the audio analysis module 400A (as described above), to further enhance user authentication
Analysis of body gestures and movements.

The Behavioral analysis module 400C receives Data from multiple sources, and analyzes that data to identify user behavioral patterns or actions. The said data sources may include:
Audiovisual data,
Data from various sensors (e.g. Smartphone motion sensors),
Data from user interfaces (e.g. mouse movements, mouse clicks, keyboard typing)

According to some embodiments, the authentication process may incorporate such behavioral data to identify patterns that are unique to a specific user.

According to some embodiments, an active authentication process may incorporate such behavioral data as part of a requirement presented to the user (e.g. “Please move your Smartphone in the left direction”).

The Authentication assessment module 500 receives the results from all analysis modules (400A, 400B, 400C) and determines whether the authentication score has passed a predefined threshold in relation to a sensitivity parameter set by the authentication control module 600. It then propagates the result to the authorizing entity 30, indicating successful or unsuccessful authentication.

The Authentication control module 600 implements the authentication policy dictated by the Authorizing entity 30. It does so by managing the type and the properties of required authentication methods.

The Authentication control module 600 takes at least one of the following parameters into account:
The authorizing entity's authentication policy. For example, a bank may require minimal security for accessing stock exchange pages, but maximal security when accessing personal accounts.
Predefined rules, associating authentication methods with different levels of authentication (e.g. username and password vs. active audiovisual data).
Predefined properties per each of the authentication methods. For example, in the case of visual face recognition, this parameter may be the camera's image sample rate.
Sensitivity parameters, accommodating a degree of tradeoff between false positive and true negative authentications. For example, a certain degree of erroneous authentication decisions may be deemed acceptable, in order to provide a streamlined user experience.
The user profile (e.g. role in an organization).
Parameters indicating of usage type or level of security, such as: time of day, the currently used device type (PC, Laptop smart phone), current location of the user, current security level of the authority system.
The control module further determines sensitivity parameters based on analyzed and tracked behavior,

The Authentication control module 600 may dynamically change parameters such as the authentication method such as face recognition, voice passwords or any combination, authentication properties and sensitivity parameters according to analyzed authentication data and monitored user behavior.

According to some embodiments, the Authentication control module 600 may oversee and combine the authorization processes against more than one user device 20. This capability accommodates user authentication in cases where, for example, the approval of more than one individual is required in order to promote a certain task.

According to some embodiments, the Authentication procedure may require multiple users actions to authenticate or preform specific action. For example requiring two authentication keys or signatures of two different users, to authenticate one action for performing financial operation

The authorizing entity 30 receives authentication assessment data from the authentication assessment module 500. This data indicates whether or not the authorization has succeeded, and whether the authorizing entity 30 should grant access to the user device 20.

FIG. 2 illustrates the operation of the Passive monitoring module 200, according to some embodiments of the present invention.

The process comprises the following steps:
The authentication control module 600 identifies a triggering event, originating either by a system condition or user action (e.g. when a user is accessing their bank account) for activating continuous passive monitoring (e.g. continuously produce camera image captures) (step 210).
The Passive monitoring module 200 receives control data from the authentication control module 600. This data contains, for example, the method of passive authentication (e.g. face recognition through continuous camera image captures) and appropriate authentication parameters (e.g. image capture rate) (step 212).
The Passive monitoring module 200 activates continuous passive monitoring, according to the triggering event and control data (step 214)
The Passive monitoring module 200 propagates passive monitoring data (e.g. captured image frames) to the analysis module 400 (step 216)
The Passive monitoring module 200 obtains the result of the authorization analysis, and propagates the result to the authentication assessment module 500, which would ascertain whether the authentication has succeeded or not (step 218)
The Passive monitoring module 200 also propagates the result of the authentication analysis obtained from the authentication analysis module 400 to the control module 600, which would ascertain whether to make any adjustments or refinements in the authentication process or any of its properties (step 220)

FIGS. 3A and 3B jointly illustrate the operation of the active monitoring module 300, according to some embodiments of the present invention. The process comprises the following steps:
The authentication control module 600 identifies a triggering event, originating either by a system condition or user action for activating active monitoring (e.g. initiate continuous camera image captures) (step 310).
Receiving control data (i.e. method of active authentication and appropriate parameters) from the control module (step 312)
Initiating authentication procedure by sending instructions to the user terminal 20, according to the control data and the triggering events (e.g. requiring the user to enter passwords, provide biometric authentication: fingerprints, image sample, voice sample, video recording) (step 314)
According to some embodiments, the active monitoring module 300 authenticates the user's identity by receiving a random sentence from the random sentence generator module 40, and requiring the user to read it. (step 316-A)
According to some embodiments, the active monitoring module 300 authenticates the user's identity by generating a sentence relevant to the user's actions (e.g. performing a bank transfer), and requiring the user to read it. (step 316-B). optionally the generated sentences include informative information, such as security instructions.
According to some embodiments, the active monitoring module 300 transmits a sentence through cellular network by using voice call or SMS, to avoid man in the middle attack (step 316-C).
The phonetic parsing module 50 parses the recorded sentences to individual phonemes, or combined phoneme (Bi-phoneme, Tri-phone) and compared these phonemes to user-specific patterns to obtain user authentication. (step 318)
According to some embodiments, the active monitoring module 300 authenticates the user's identity by requiring the user to perform specific actions while recording them on video, and verifying the performance of the said actions by analyzing the said video recordings (step 320), the requirement to perform actions may include random instruction such moving the hand or the hand at random route or a random pattern for the eyes to follow while we detect the eye movement;
According to some embodiments, the active monitoring module 300 enhances the authentication of the user's identity by combining several active authentication methods. For example, the user may be required to utter a sentence, while both audio (phoneme detection) and video (lips movement) are analyzed and correlated, to ascertain the correctness of the action (uttering a sentence) and identity of the user (voice recognition, face recognition) (step 322)
The active monitoring module 300 receives the required active authentication data from the user device 20 (step 324)
The active monitoring module 300 propagates the active authentication data (e.g. voice recording) to the analysis module 400 (step 326)
The active monitoring module 300 obtains the result of the authorization analysis from the analysis module 400, and propagates the result to the authentication assessment module 500, which would ascertain whether the authentication has succeeded or not (step 328)
The active monitoring module 300 also propagates the result of the authentication analysis obtained from the authentication analysis module 400 to the control module 600, which would ascertain whether to make any adjustments or refinements in the authentication process or any of its properties (step 330)

FIG. 4A illustrates the operation of the audio analysis module, according to some embodiments of the present invention. The process comprises the following steps:
Receiving sound recording of the user (step 405A)
For random sentence Activating Phonetical parsing generator module (step 410A)
Compare parsed phonetical audio data to user authenticated phonetical audio data (step 414)
Analyze sound recording characteristics: amplitude (loudness), pitch, or frequency (step 430);
Identifying speech pattern specific to the user based on comparison results and/or analyzing sound recording characteristic (step 440);
Send comparison results to the assessment module (step 450)

FIG. 4B illustrates a video analysis module, according to some embodiments of the present invention. The process comprises the following steps:
Receiving video recording of the user (step 405B)
Perform video to video comparison analysis using user reference video recording (step 410B)
Perform facial image recognition of face articulation in relation to sound analysis of spoken sentence, including lips motion analysis (step 420B)
Check synchronization of lips motion to random sentence words based phonetic parsing of the sentence (step 430B);
Check lips motion to identify opening of the mouth, stretching of the lips to identify level/intensity of speech comparing to audio recording speech volume (step 440);
Track motion of user organs, head eye movement module (step 450)
Send comparison results to assessment module (step 446B)

FIG. 4C illustrates the operation of the behavioral analysis module, according to some embodiments of the present invention. The process comprises the following steps:
Receiving behavioral data such as motion data of user organs or movement of user smartphone device, typing actions of the user or Mouse cursor movement (step 410C)
Analyze all Motion data according to predefined rules such as user identified normal behavior (step 420c)
Send comparison results to assessment module (step 430C)

FIG. 5 illustrates the operation of the assessment module, according to some embodiments of the present invention. The process comprises the following steps:
Receiving analysis results from all analysis modules (step 510)
Determine authentication assessment score based on predefined authentication rules, user profile, entity profile by integrating all authentication analysis comparison results using dynamically updated authentication weights determined by the control module (step 520)
Sending assessment to the authorizing entity (step 530)

FIG. 6 illustrates the operation of the control module, according to some embodiments of the present invention. The process comprises the following steps:
Receiving analysis results from all analysis modules (step 610)
Receiving tracking data from passive and active capturing modules (step 620)
By analyzing received data, determining authentication sensitivity parameters based on user profile, context (location, time, current action IP address etc.) and authorizing entity profile (step 630)
Based on sensitivity parameters determine control parameters for passive capturing module using predefined sensitivity rules (e.g. frequency of capturing user face) (step 640)
Based on sensitivity parameters determine control parameters for active capturing module using predefined sensitivity rules (e.g. instruct user to enter passwords for specific action) (step 650)
Update authentication weights for each type of authentication methods (e.g. voice recognition) for assessment module based on sensitivity parameters, user profile and entity profile (step 660) or determine level of comparison threshold parameters, such as degree of similarity between images.

FIG. 7 is an illustration of a flow chart of the Sign-In process module, according to some embodiments of the present invention. The process is activated upon user prompt to login; (step 710), first analyzing user profile, context parameters such as location, type of device in use, (step 720). By analyzing received data, the module determines authentication sensitivity parameters based on user profile, context parameters authorizing entity profile (step 730). Based on sensitivity parameters is determine sign in procedure: type of authentication. (step 740). Once the sign-in procedure (enrollment procedure)is selected, the process prompt user with sign in requirements accordingly (step 750) and receives user data based on requirements and authenticate data; (step 760) (—just to make sure: the sign-in procedure is the enrollment procedure, where a user introduces herself to the system or in other words—registers with the system? Because that's what we call sign-in—)

Optionally a procedure of incremental enrollment can be implemented, receiving just a few sentences from the user at the beginning, and then requiring user to say additional sentences during the first login actions to serve as further enrollment process.

The procedure of incremental enrollment can be implemented for each authentication method such as face recognition, or voice recognition, where at each login process are added facial or voice data

FIG. 8 is an illustration of a flow chart of the Authentication through login session module, according to some embodiments of the present invention.

This module processing is activated once the user logged in (step 810), continuously analyzing user profile, context parameters; (step 820) and Monitoring user behavior and activities (step 830).

By analyzing received data, determining authentication sensitivity parameters based on user profile, context parameters authorizing entity profile and user activities and behavior;

Continuously, based on authentication sensitivity parameters, the process determines active prevention action or authentication action; (step 840)

The action may include: Prompt user with requirements, stop session, enable or prevent from user privileged access or action (step 850), if required receiving user response data based on requirements and authenticate data (step 860).

FIG. 9 is an illustration of a flow chart of Phonetic parsing module, according to some embodiments of the present invention. The parsing module apply the following steps: Receiving user recorded sentence (step 910), applying voice recognition to identify text, words, of recorded sentences, (step 920), optionally parse text into phonemes or use given known phonetic(step 930), analyzing voice of user for identifying and parsing audio into phoneme and combination of sequence phonemes based on the known phonetics of the text (step 940)

According to some embodiments of the present invention analyzing voice of user for identifying unique speech patterns identifying the user. (step 950)

Optionally Applying learning algorithm to enhance the identification of phonemes based on previous phoneme identification (step 960).

Transferring individual phonemes audio or combination of phonemes of recording to database (step 970)

FIG. 10 is an illustration of a flow chart of User Phonetic training module, according to some embodiments of the present invention. The Phonetic training module applies the following steps: requiring user to record predefined set of sentences including all required phonemes as required by the sensitivity parameters or sentences including unique speech pattern relevant for the specific user (step 1110), receiving user recorded sentence (step 1120), applying voice recognition to identify text, words, of recorded sentences, (step 1130), optionally parse text into phonemes or retrieve known phonemes of the sentence (step 1140), analyzing voice of user and applying learning algorithm for identifying and parsing audio into segments, each segment including one phoneme based on identified phonetics in the text (step 1150) and Maintaining individual phonemes audio on recording (step 116).

FIG. 11 is an illustration of a flow chart of Random sentence generator module, according to some embodiments of the present invention.

The Phonetic training module apply the following: defining selection of phoneme based on required sensitivity parameters (step 1210), randomly selecting words or sentences from prepared text book where the words include selection phoneme (step 12220) and optionally Randomly selecting words or sentences from prepared text book where the words include speech patterns of specific user

The present invention may be described, merely for clarity, in terms of terminology specific to particular programming languages, operating systems, browsers, system versions, individual products, and the like. It will be appreciated that this terminology is intended to convey general principles of operation clearly and briefly, by way of example, and is not intended to limit the scope of the invention to any particular programming language, operating system, browser, system version, or individual product.

It is appreciated that software components of the present invention including programs and data may, if desired, be implemented in ROM (read only memory) form including CD-ROMs, EPROMs and EEPROMs, or may be stored in any other suitable typically non-transitory computer-readable medium such as but not limited to disks of various kinds, cards of various kinds and RAMs. Components described herein as software may, alternatively, be implemented wholly or partly in hardware, if desired, using conventional techniques. Conversely, components described herein as hardware may, alternatively, be implemented wholly or partly in software, if desired, using conventional techniques.

Included in the scope of the present invention, inter alia, are electromagnetic signals carrying computer-readable instructions for performing any or all of the steps of any of the methods shown and described herein, in any suitable order; machine-readable instructions for performing any or all of the steps of any of the methods shown and described herein, in any suitable order; program storage devices readable by machine, tangibly embodying a program of instructions executable by the machine to perform any or all of the steps of any of the methods shown and described herein, in any suitable order; a computer program product comprising a computer useable medium having computer readable program code, such as executable code, having embodied therein, and/or including computer readable program code for performing, any or all of the steps of any of the methods shown and described herein, in any suitable order; any technical effects brought about by any or all of the steps of any of the methods shown and described herein, when performed in any suitable order; any suitable apparatus or device or combination of such, programmed to perform, alone or in combination, any or all of the steps of any of the methods shown and described herein, in any suitable order; electronic devices each including a processor and a cooperating input device and/or output device and operative to perform in software any steps shown and described herein; information storage devices or physical records, such as disks or hard drives, causing a computer or other device to be configured so as to carry out any or all of the steps of any of the methods shown and described herein, in any suitable order; a program pre-stored e.g. in memory or on an information network such as the Internet, before or after being downloaded, which embodies any or all of the steps of any of the methods shown and described herein, in any suitable order, and the method of uploading or downloading such, and a system including server/s and/or client/s for using such; and hardware which performs any or all of the steps of any of the methods shown and described herein, in any suitable order, either alone or in conjunction with software. Any computer-readable or machine-readable media described herein is intended to include non-transitory computer- or machine-readable media.

Any computations or other forms of analysis described herein may be performed by a suitable computerized method. Any step described herein may be computer-implemented. The invention shown and described herein may include (a) using a computerized method to identify a solution to any of the problems or for any of the objectives described herein, the solution optionally include at least one of a decision, an action, a product, a service or any other information described herein that impacts, in a positive manner, a problem or objectives described herein; and (b) outputting the solution.

The scope of the present invention is not limited to structures and functions specifically described herein and is also intended to include devices which have the capacity to yield a structure, or perform a function, described herein, such that even though users of the device may not use the capacity, they are, if they so desire, able to modify the device to obtain the structure or function.

Features of the present invention which are described in the context of separate embodiments may also be provided in combination in a single embodiment.
For example, a system embodiment is intended to include a corresponding process embodiment. Also, each system embodiment is intended to include a server-centered “view” or client centered “view”, or “view” from any other node of the system, of the entire functionality of the system, computer-readable medium, apparatus, including only those functionalities performed at that server or client or node.

1. A method for dynamically adjusting authentication procedure of user access to an authorizing entity or action using a computerized device, said method implemented by one or more processors operatively coupled to a non-transitory computer readable storage device, on which are stored modules of instruction code that when executed cause the one or more processors to perform:
f. online tracking user behavior including login action in response to authentication procedure requirement, continuous passive behavior after login or active behavior in response to authentication procedure requirement;
g. analyzing user behavior and authentication data received from the user;
h. determining sensitivity authentication parameter based on analyzed and track behavior data;
i. dynamically changing authentication procedure requirement based on determined sensitivity authentication parameter user profile and/or authorizing entity;
j. dynamically changing authentication assessment based on determined sensitivity authentication parameter.

2. The method of claim 1 where initiating authentication procedure include sending instructions to the user terminal, according to the control data and the triggering events.

3. The method of claim 1 further comprising the step of authenticating the user's identity by requiring the user to perform specific actions while recording them on video, and verifying the performance of the said actions by analyzing the said video recordings.

4. The method of claim 1 further comprising the step of identifying a triggering event, originating either by a system condition or user action for activating active monitoring

5. The method of claim 1 further comprising the step of determining authentication assessment score based on predefined authentication rules, user profile, entity profile by integrating all authentication analyses comparison results using dynamically updated authentication weights

6. The method of claim 1 further comprising the step of receiving behavioral data including at least one of: motion data of user organs or movement of user smartphone device, typing actions of the user or Mouse cursor movement.

7. The method of claim 1 further comprising the step of analyzing all Motion data according to predefined rules such user identified normal behavior.

8. The method of claim 1 wherein based on sensitivity parameters determining control parameters for passive capturing module using predefined sensitivity rules (e.g. frequency of capturing user face)

9. The method of claim 1 further comprising the step of wherein based on sensitivity parameters determine control parameters for active capturing module using predefined sensitivity rules

10. The method of claim 1 further comprising the step of updating authentication weights for each type of authentication methods for assessment module based on sensitivity parameters, user profile and entity profile or determine level of comparison thresholds parameters

12. The method of claim 1 wherein the sensitivity parameters determination are further based on context parameters including at least one of: geo location, time, IP address.

13. A system for dynamically adjusting authentication procedure of user access to an authorizing entity or action using a computerized device, said system comprising one or more processing devices operatively coupled to a non-transitory storage device, on which are stored modules of instruction code that when executed cause the one or more processing devices to perform:
a. monitoring module for online tracking user behavior including login action in response to authentication procedure requirement, continuous passive behavior after login or active behavior is response to authentication procedure requirement;
b. analysis module for analyzing user behavior and authentication data received from the user;
c. Authentication control module for determining sensitivity authentication parameter based on analyzed and track behavior data and dynamically changing authentication procedure requirement based on determined sensitivity authentication parameter user profile and/or authorizing entity;
d. Authentication assessment module dynamically changing authentication assessment based on determined sensitivity authentication parameter

14. The system of claim 12 where initiating authentication procedure by sending instructions to the user terminal, according to the control data and the triggering events.

15. The system of claim 12, wherein authentication control module further comprising the step of authenticating the user's identity by requiring the user to perform specific actions while recording them on video, and verifying the performance of the said actions by analyzing the said video recordings.

16. The system of claim 12 further wherein the monitoring comprising the step of identifying a triggering event, originating either by a system condition or user action for activating active monitoring

17. The system of claim 12 wherein the authentication control module further comprising the step of determining authentication assessment score based on predefined authentication rules, user profile, entity profile by integrating all authentication analyses comparison results using dynamically updated authentication weights

18. The system of claim 12 wherein the monitoring, module further comprising the step of receiving behavioral data including at least one of: motion data of user organs or movement of user smartphone device, typing actions of the user or Mouse cursor movement.

19. The system of claim 12 further comprising the step of analyzing all Motion data according to predefined rules such user identified normal behavior.

19. The system of claim 12 wherein based on sensitivity parameters determining control parameters for passive capturing module using predefined sensitivity rules (e.g. frequency of capturing user face)

20. The system of claim 12 wherein authentication control module further comprising the step of wherein based on sensitivity parameters determine control parameters for active capturing module using predefined sensitivity rules

21. The system of claim 12 wherein the authentication control module further comprising the step of updating authentication weights for each type of authentication methods for assessment module based on sensitivity parameters, user profile and entity profile or determine level of comparison thresholds parameters

22. The system of claim 12 wherein the sensitivity parameters determination are further based on context parameters including at least one of: geo location, time, IP address.
